(19) United States
(12) Patent Application Publication
(10) Pub. No.: US 2023/0331032 A1
(43) Pub. Date: Oct. 19, 2023

(54) ATTACHMENT ASSEMBLY INCLUDING FASTENING MECHANISMS

(71) Applicants: Tony Argueta, West Covina, CA (US); Cecilia Hernandez-Argueta, West Covina, CA (US)

(72) Inventors: Tony Argueta, West Covina, CA (US); Cecilia Hernandez-Argueta, West Covina, CA (US)

(21) Appl. No.: 18/135,763

(22) Filed: Apr. 18, 2023

Related U.S. Application Data
(60) Provisional application No. 63/332,360, filed on Apr. 19, 2022.

(51) Int. Cl. B44C 3/12; B25B 5/00; B25B 5/04; B25B 5/10

(52) U.S. Cl. CPC B44C 3/12; B25B 5/003; B25B 5/04; B25B 5/101

(57) ABSTRACT

An attachment assembly for securing party decorations to support structures. The attachment assembly includes a clamp device to attach the attachment assembly to a support structure and one or more fastening mechanisms configured with the clamp device to secure party decorations. A first fastening mechanism includes a through-hole passing through the clamp device and a second fastening mechanism includes a rotatable clamp member biased against an outer surface of the clamp device. Party decorations, such as balloon tie strings, garland, streamers, ribbons, etc., are secured to the clamp device using the fastening mechanisms and the clamp device is securable to a support structure such as a railing, fence, table, etc.

### CROSS-REFERENCE TO RELATED APPLICATIONS

This application claims priority to U.S. Provisional Application No. 63/332,360, filed Apr. 19, 2022, the entire contents of which are hereby fully incorporated herein by reference for all purposes.

### FIELD OF THE INVENTION

The present invention belongs to the field of attachment devices, including attachment devices with fastening mechanisms adapted to secure party decorations.

### BACKGROUND

Throughout the world, party decorations are used to create fun and exciting backdrops to celebrations of all kinds, from birthday parties and weddings to concerts and festivals. Such party decorations oftentimes include balloons tied with strings, streamers, garlands, and other types of decorations.

As is known in the art, such decorations are typically tied to support structures such as bannisters, tables, chairs, fences, and other types of structures. However, in order to tie a balloon string or streamer to a support structure, the support structure must include an area suitable for tying or otherwise attaching (e.g., an opening through which the string may be looped and tied). Accordingly, suitable support structures may be limited and may not be located in the most desirable areas. In addition, once tied, the party decorations may be difficult to remove once the celebration is over.

Accordingly, there is a need for attachment devices that enable party decorations to be attached to a wider family of support structures. There also is a need for attachment devices that facilitate the easy removal of the party decorations once the decorations are no longer needed.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows an attachment assembly in accordance with exemplary embodiments hereof;

FIGS. 2-3 show a side view of the attachment assembly of FIG. 1 in accordance with exemplary embodiments hereof;

FIGS. 3A-3B show corresponding ridges in accordance with exemplary embodiments hereof; and

FIGS. 4-7 show additional embodiments of an attachment assembly in accordance with exemplary embodiments hereof.

### DETAILED DESCRIPTION OF EXEMPLARY EMBODIMENTS

In general, the assembly according to exemplary embodiments hereof provides an attachment assembly for securing objects to support structures. In some embodiments, the objects may include party decorations such as balloons, garland, streamers, ribbons, and other types of party decorations. In some embodiments, the attachment assembly includes a clamp device or other type of attachment mechanism coupled with a fastening mechanism to secure the party decorations. In this way, the attachment assembly may be attached to a support structure and the party decorations may be secured to the attachment assembly.

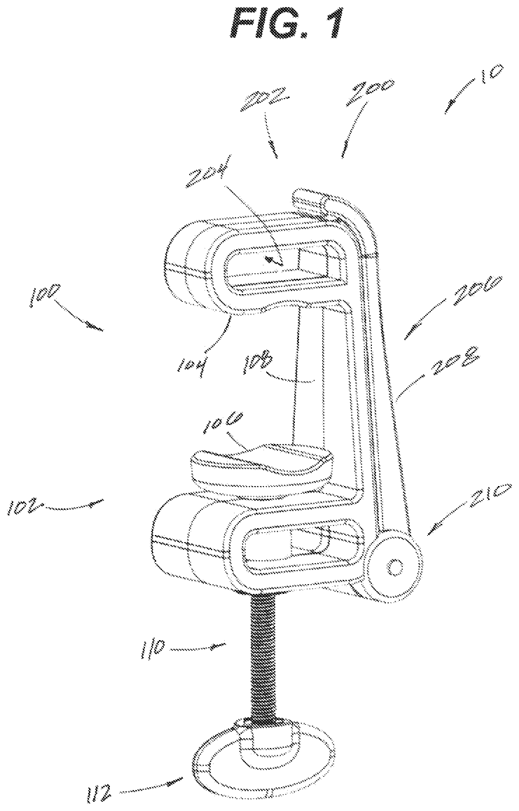

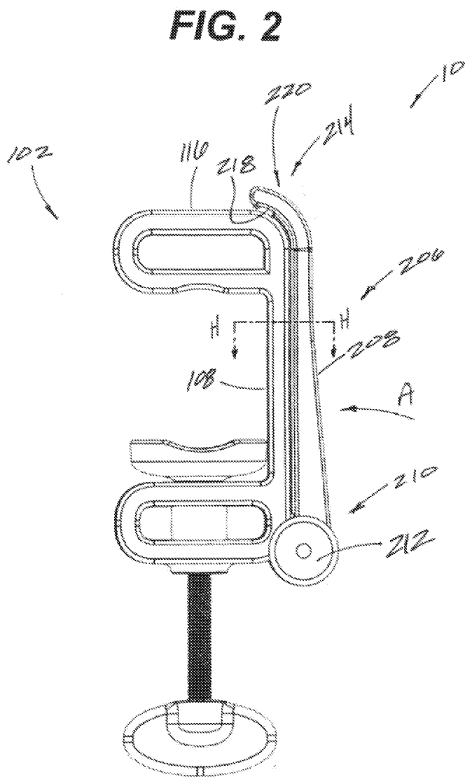

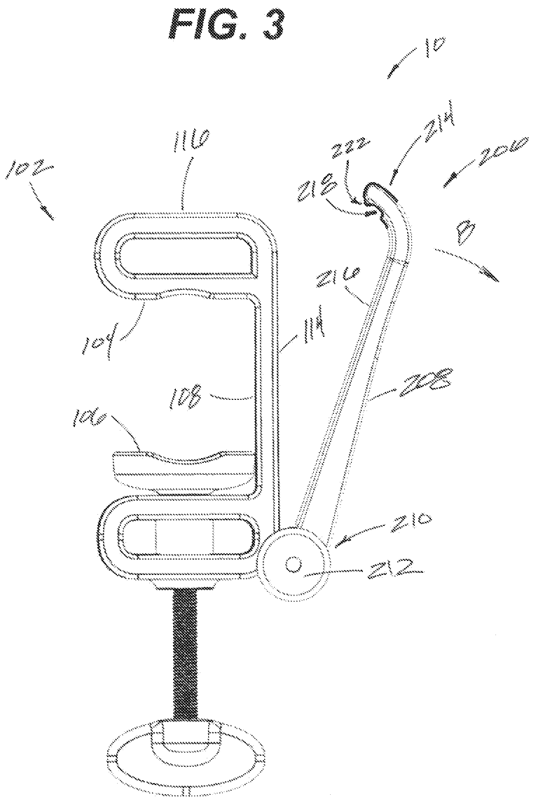

FIG. 1 shows an isotropic view of the attachment assembly 10 (also referred to herein as simply the assembly 10) according to exemplary embodiments hereof, and FIG. 2 shows a side view of the same. As shown, the assembly 10 includes an attachment mechanism 100 and a fastening mechanism 200. In general, the attachment mechanism 100 facilitates the attachment of the assembly 10 to a support structure (e.g., a railing, banister, table, chair, fence, gate, etc.) and the fastening mechanism 200 facilitates the attachment of one or more party decorations to the attachment mechanism 100. The assembly 10 may include other elements and components as necessary for the assembly 10 to perform its functionalities as described herein.

### Attachment Mechanism 100

In some embodiments, as shown in FIG. 1, the attachment mechanism 100 includes a clamp device 102. In some embodiments, the clamp device 102 includes a C-clamp (also referred to as a G-clamp or a screw clamp), a spring clamp, a pipe clamp, a hose clamp, a table clamp, a quick-release clamp, a bar clamp, a scissor clamp, other suitable types of clamps, and any combinations thereof.

For the purposes of this specification and for demonstration, the attachment mechanism 100 will be described primarily as a C-clamp as shown in FIG. 1. However, it is understood that the attachment mechanism 100 may include any type of suitable clamp and that the scope of the assembly 10 is not limited in any way by the type of clamp utilized.

In some embodiments, as shown in FIG. 1, the clamp device 102 includes a first jaw 104, a second jaw 106 and a back support 108 supporting and extending between the first and second jaws 104, 106. In some embodiments, at least one of the first and/or second jaws 104, 106 are movable so that the distance between the jaws 104, 106 may be adjusted to close the jaws 104, 106 about the support structure to which the assembly 10 may be attached.

In some embodiments, the second jaw 106 includes a screw mechanism 110 configured with a gripping portion 112 (e.g., a thumbscrew) such that by rotating the gripping portion 112 in a first direction (e.g., clockwise) the second jaw 106 may be caused to move upward for clamping the assembly 10 to a support structure and/or by rotating the gripping portion 112 in a second direction (e.g., counterclockwise) the second jaw 106 may be caused to move in a downward direction for releasing the assembly 10 from the support structure. In this way, the attachment mechanism 100 (and the overall assembly 10) may be attached to a support structure for use and subsequently released from the support structure for stowage.

While the above description describes the first and second jaws 104, 106 as being closed and/or separated using a screw mechanism 110, it is understood that the first and second jaws 104, 106 may be closed and/or separated using any other suitable type of mechanism including, but not limited to, a spring-loaded mechanism, a rail mechanism, and/or any other type of mechanism depending on the type of clamping mechanism 102 as described in other sections.

### Fastening Assembly 200

In some embodiments as shown in FIGS. 1 and 2, the fastening assembly 200 includes one or more fastening devices 202 adapted to facilitate the easy attachment of one or more party decorations to the attachment mechanism 100.

In some embodiments, as shown in FIGS. 1 and 2, a first fastening device 202 includes a through-hole 204 that passes through the side of the first jaw 104, the second jaw 106, and/or the back support 108. In this way, party decorations (e.g., balloon strings, streamers, etc.) may be looped through the through-hole 204 and tied. While FIGS. 1 and 2 show a single through-hole 204 passing through the first jaw 104, it is understood that the assembly 10 may include any number of through-holes 204 passing through any portion of the assembly 10 (e.g., through the first jaw 104, the second jaw 106, the back support 108, and/or any combinations thereof).

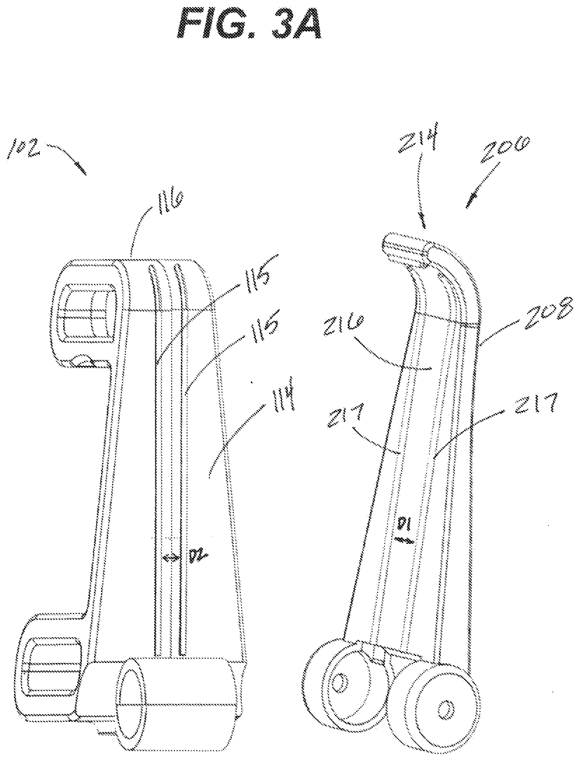

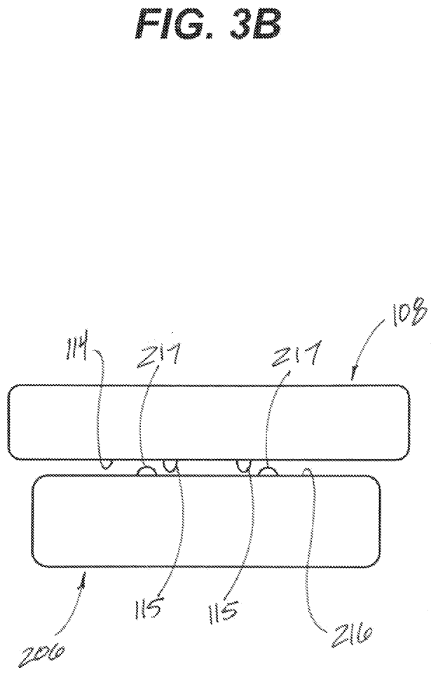

In some embodiments, as shown in FIGS. 1-3, a second fastening device 202 includes a fastening clamp member 206 adapted to clamp a party decoration (e.g., a balloon tie string, a streamer, etc.) to a portion of the clamp device 102. In some embodiments, the clamp member 206 includes an elongate body 208 with a proximal end 210 rotatably coupled to the clamp device 102. In some embodiments, as shown in FIG. 2, the clamp member's proximal end 210 may be located generally to the side of the second jaw 106 (e.g., towards the bottom of the clamp device 102 in FIG. 2) and the clamp member's distal end 214 may extend upward to the side of the first jaw 104. When at rest, the clamp member 206 may generally rest against the outer surface 114 (see FIG. 3) of the fastening device's back support 108. Other suitable locations of the clamp member 206 against the clamp device 102 also are contemplated.

In some embodiments, the clamp member's proximal end 210 includes a bias mechanism 212, e.g., a torsion spring, configured to apply a torque or rotary force to the clamp member body 208 in the direction of the arrow A in FIG. 2. This force may cause the clamp member's body 208 to remain generally flush (when at rest) against the clamp device 102 (e.g., flush against the outer surface 114).

In some embodiments, as shown in FIG. 3, the clamp member body 208 may be rotated outward from the device 102 about its proximal end 210 in the direction of the arrow B by applying an outward force to the body 208 greater than the rotary force provided by the bias mechanism 212. In this way, the clamp member 206 may be opened such that a party decoration (e.g., a balloon tie string, a streamer, etc.) may be placed within the gap between the clamp member body 208 and the outer surface 114 to be held therein. The clamp member body 208 may then be released and the bias mechanism 212 may cause the clamp member body 208 to return to its flush position against the device 102. It is preferred that the bias mechanism 212 apply sufficient force to the clamp member body 208 (in the direction of the arrow A) thereby holding it against the device 102 such that the party decoration is held between the clamp device 206 and the outer surface 114 until intentionally removed (e.g., by rotating the clamp member body 208 outward in the direction of the arrow B by force).

In some embodiments, as shown in FIG. 3, the upper portion of the clamp device 102 includes an upper surface 116, and the distal end 214 of the clamp member body 208 extends from the outer surface 114 to overlap a portion of the upper surface 116. In some embodiments, the corner junction between the outer surface 114 and the upper surface 116 may be rounded and the distal end 214 of the clamp member body 208 may follow a corresponding contour so that the clamp member body 208 remains flush against the outer surface 114, the upper surface 116, and the corner between the outer and upper surfaces 114, 116. In this way, party decorations may be held between the clamp member body 208 and the outer surface 114 and between the clamp member body 208 and the upper surface 116 (including the corner therebetween) simultaneously.

In some embodiments, as shown in FIG. 3, the inner surface 216 of the clamp member body 208 includes one or more notches 218 that provide corresponding gaps between the clamp member body 208 and the outer and/or upper sides 114, 116 of the clamp device 102 when the clamp member body 208 is held flush against the clamp device 102 (also see FIG. 2). In this way, individual party decorations may be held in the notches 218 and be kept separate from one another. The notches 218 may be formed directly into the inner surface 216 and/or may be formed by applying a layer (e.g., padding) to the inner surface 216 with gaps or openings in the layer that form the notches 218. It also is contemplated that the padding (e.g., rubber and/or foam) may assist in keeping party decorations held between the inner surface 216 of the clamp member body 208 and the outer and/or upper sides 114, 116 of the clamp device 102 in place due to the pressing of the padding against the outer and/or upper sides 114, 116 of the clamp device 102 with the party decorations held therebetween.

A single notch 218 towards the distal end 214 of the clamp member body 208 where the clamp member body 208 extends over the top surface 116 of the clamp device 102 is shown in FIGS. 2-3. The location of this notch 218 where the clamp member body 208 translates from a generally upward direction to a generally horizontal direction enables a user to slip a party decoration (e.g., a balloon tie string, streamer, etc.) into the notch 218 without having to deflect the clamp member body 208 more than the width of the party decoration (e.g., 1 mm-2 mm) thereby keeping other party decorations held in other areas between the clamp member body 208 and the clamp device 102 secure.

It also is understood that any number of notches 218 at any locations on the clamp member body 208 may be provided. It also is contemplated that the outer and/or upper surfaces 114, 116 also may include one or more notches formed in similar ways and used for similar purposes.

In addition, the distal portion 214 of the clamp member body 208 forms a hook portion 220 as it translates from a generally upward direction (flush against the outer surface 114) to a generally horizontal direction (flush against the upper surface 116). This hook portion 220 is designed to hold party decorations being held by the clamp member 206 at a lower position that may have slipping upward during use. As the party decorations slip/move upwards, once they reach the area of the hook portion 220, the hook portion 220 holds the decorations from being inadvertently released. In addition, the notch 218 positioned in the area of the hook portion 220 also may facilitate the holding of any slipping decorations. It is understood that the distal end 214 (e.g., the hook portion 220) may extend across the upper surface 116 of the clamp device 102 any distance from its junction with the outer surface 114 and towards the side opposite the outer surface 114.

In some embodiments, as shown in FIG. 3, the clamp member 206 and/or the clamp device 102 includes a locking mechanism 222 that releasably locks the clamp member 206 pressed against the clamp device 102 when in the holding position. The locking mechanism 222 may include a detent, a latch, a clip, any other suitable locking mechanism 222, and any combinations thereof.

In some embodiments, as shown in FIGS. 3A-3B, the clamp member body's inner surface 216 includes one or more (e.g., two as shown) raised ridges 217 that extend generally from the proximal end 210 to the distal end 214 (or any portions thereof). In some embodiments, the inner surface 216 includes two or more raised ridges 217 in a side-by-side and parallel arrangement as shown. The raised ridges 217 may be about 1 mm-2 mm wide, may extend outward from the surface 216 about 1 mm-2 mm, and may be spaced apart from one another by a first distance D1 (e.g., wherein D1 equals a suitable distance, e.g., 5 mm-20 mm). It is understood that other dimensions also may be used.

In addition, in some embodiments, as shown in FIGS. 3A-3B, the clamp device's outer surface 114 may include one or more (e.g., two as shown) raised ridges 115 that generally correspond to the raised ridges 217 on the surface 216 but that are spaced apart from one another by a second distance D2. The purpose of the raised ridges 217 and corresponding raised ridges 115 is to apply small folds to the party decorations held between the surfaces 114, 216 when the clamp member 208 is pressed against the clamp device 102, thereby preventing the party decorations from slipping laterally.

FIG. 3B shows a sectional view of the clamp member body's inner surface 216 pressed against the clamp device's outer surface 114 taken from the perspective of cutlines H-H of FIG. 2. As shown, the raised ridges 217 on the inner surface 216 are aligned next to the raised ridges 115 on the outer surface 114. The arrangement shown in FIG. 3B shows D1>D2 (by 1 mm-5 mm) thereby aligning the corresponding ridges 217, 115 next to one another. It also is contemplated that D2>D1 by a similar amount, or that D1=D2 in which case the ridges 115 and the ridges 217 may be laterally offset from one another to the left or to the right such that the ridges 115, 217 do not collide.

In any event, it can be appreciated that a party decoration such as a balloon tie string or streamer held between the corresponding raised ridges 115, 217 may be folded (e.g., zigzagged) as it passes between the ridges 115, 217 when the clamp member 206 is closed. In this way, the party decoration may be further secured between the ridges 115, 217.

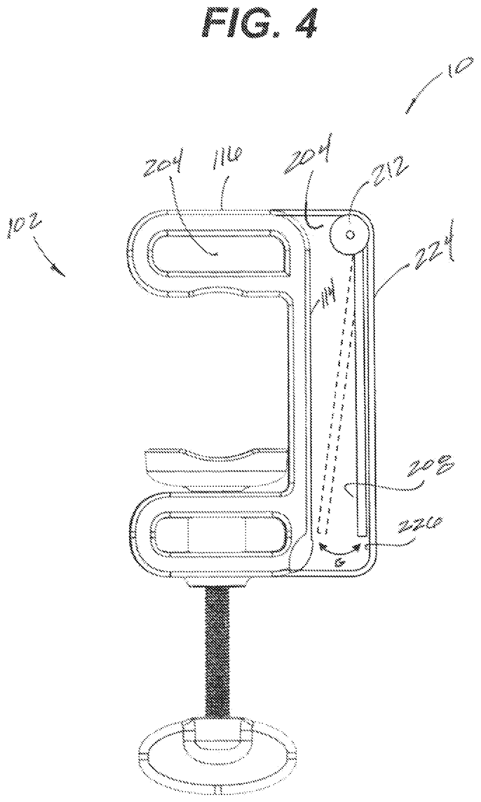

In some embodiments, a clamp member 206 may be configured within a through-hole 204. For example, as shown in FIG. 4, a through-hole 204 may be formed between the clamp device's outer surface 114 and the inner surface 226 of an outer frame member 224. In this arrangement, the clamp member body 208 may be configured within the through-hole 204 with its proximal end rotatable about a bias mechanism 212. In this way, the clamp member body 208 may be held against the inner surface 226 to hold party decorations therebetween. The clamp member body 208 may be rotated open and closed in the direction of the arrow G. While the bias mechanism 212 is shown in the upper portion of the through-hole 204, it is understood that the bias mechanism 212 may be positioned anywhere within the through-hole 204 as desired. It also is understood that the clamp member body 208 may be configured to be held against any suitable surface to hold party decorations therebetween.

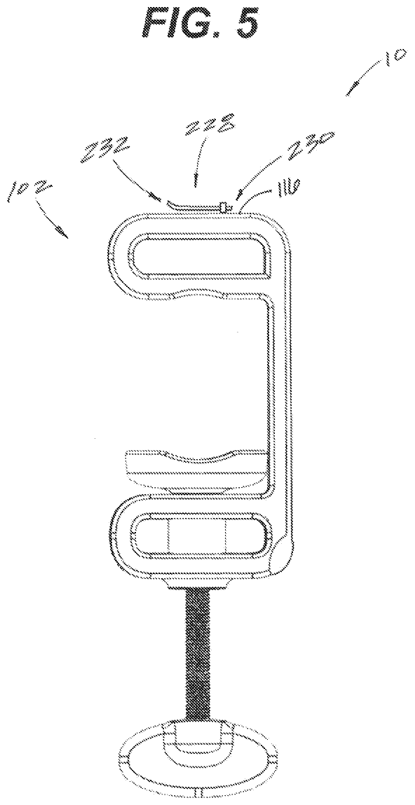

In some embodiments, as shown in FIG. 5, a third fastening device 202 includes a clamp section 228 that may be configured on a surface (e.g., the upper surface 116) of the clamp device 102. The claim section 228 may include a proximal end 230 secured to the clamp device 102 (e.g., by a screw or bolt), and a distal end 232 extending therefrom, the section 228 being generally flush with the surface of the clamp device 102 to which it is attached. In this way, a party decoration may be slipped between the clamp section 228 and the clamp device 102 and be held in place. In some embodiments, the clamp section 228 comprises spring steel or other suitable material so that the bias of the spring steel holds the party decoration secure against the clamp device 102. It may be preferable that the distal end 232 of the clamp section 228 include an upward lip to facilitate the easy slipping of the party decoration under the clamp section 228 to be secured.

In any event, it is preferable that the bias applied to the clamp member body 208 be strong enough to hold party decorations in place during use (to withstand wind, etc.) but not too strong such that the clamp device 206 may be opened to remove party decorations with normal human strength as desired.

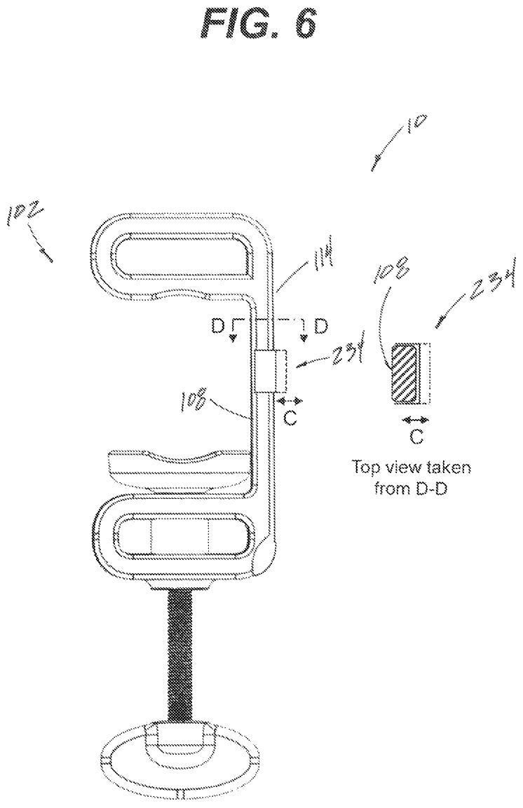

In some embodiments, a fourth fastening device 202 includes a slider clamp 234 configured with the clamp device 102 such that one or more party decorations may be clamped between the slider clamp 234 and a surface of the clamp device 102. FIG. 6 shows a side view of a slider clamp 234 configured with the clamp device 102 and a top sectional view taken from the perspective of cutlines D-D. In this example, a slider clamp 234 may be configured with the back support 108 and adapted to slide in a direction toward the outer surface 114 (see arrow C) in order to press against the outer surface 114 of the back support 108 and to hold a party decoration therebetween. The slider clamp 234 may then be moved in a direction away from the outer surface 114 (see arrow C) to release the party decoration (this position is represented by the dashed lines). In some embodiments, the slider clamp 234 may be configured to slide back-and-forth within one or more channels formed in the back support 108 and may be secured in a locked position against an outer surface 114 of the clamp device 102 using detents, locking tabs, latches, other locking mechanisms, and any combinations thereof.

While the slider clamp 234 is shown as being generally configured with the outer surface 114 and side walls of the clamp's back support 108, it is understood that the slider clamp 234 may be configured with any suitable surfaces of the clamp device 102.

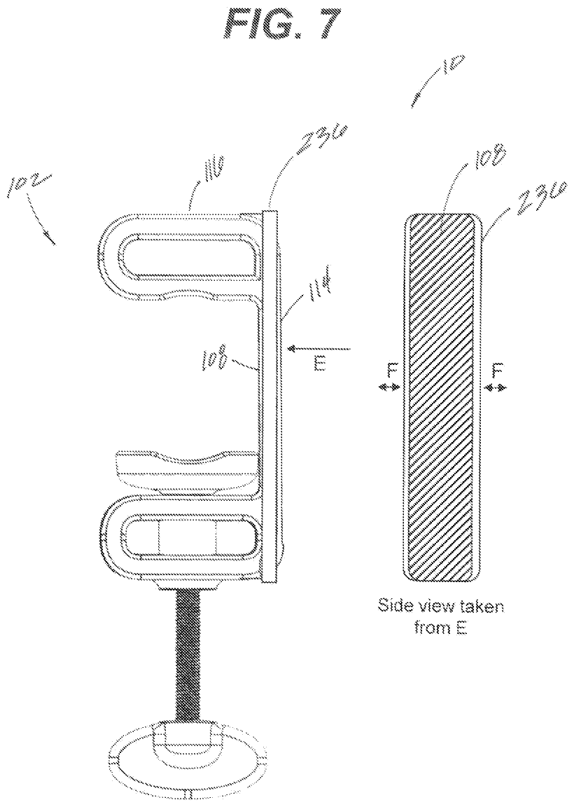

In some embodiments, a fifth fastening device 202 includes an elastic clamp 236. FIG. 7 shows a side view of an elastic clamp 236 configured with the clamp device 102 and a backside view of the clamp 236 and device 102 taken from the perspective of the arrow E. In this example, the elastic clamp 236 comprises an elastic band that may be stretched about one or more surfaces of the clamp device 102 such that the bias caused by the stretching of the elastic clamp 236 applies a force between the elastic clamp 236 and the clamp device 102 to hold a party decoration therebetween. In use, the elastic clamp 236 may be pulled away from the side surface of the clamp device 102 (see arrows F) to create a gap between the elastic clamp 236 and the device 102 for one or more party decorations to be inserted therein. The elastic clamp 236 may then be released so that it returns to a flush position against the device 102 (see arrows F) to hold the decoration thereto. While the arrows F depict the elastic clamp 236 being stretched open along the sides of the clamp device 102, it is understood that the elastic clamp 236 may be stretched open along the upper surface 114 of the device, and/or along any other surface(s) of the device 102. In some embodiments, the elastic clamp 218 may comprise an elastic band (e.g., rubber) or other suitable materials.

While FIG. 7 shows the elastic clamp 236 stretched about clamp's back support 108 from top to bottom, it is understood that the elastic clamp 236 may be stretched about any suitable surface of the clamp device 102 in any suitable direction as required.

It is understood that any number(s) and/or type(s) of fastening devices 202 may be configured with any number(s) and type(s) of attachment mechanisms 100 as desired.

It also is understood that any aspect or element of any embodiment(s) of the assembly 10 may be combined with any other aspect or element of any other embodiment(s) of the assembly 10 to form additional embodiments of the assembly 10 all of which are within the scope of the assembly 10.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An attachment assembly for attaching party decorations to a support structure, the attachment assembly comprising:
a clamp mechanism including a first clamping member, a second clamping member opposite the first clamping member, and a support member configured between the first clamping member and the second clamping member, the first clamping member and/or the second clamping member movable towards one another;
an elongate fastening mechanism including a proximal end rotatably coupled to the support member and a distal end extending therefrom;
a bias mechanism configured to apply a force to the elongate fastening mechanism in a direction that presses the elongate fastening mechanism against the support member.

2. The attachment assembly of claim 1 wherein the first clamping member includes an upper surface, and wherein the distal end of the elongate fastening mechanism is adapted to extend over at least a portion of the upper surface when the bias mechanism causes the elongate fastening mechanism to be pressed against the support member.

3. The attachment assembly of claim 1 wherein the support member includes an outer surface and the elongate fastening mechanism includes an inner surface, and wherein the bias mechanism is configured to apply the force to the elongate fastening mechanism in a direction that presses the inner surface against the outer surface.

4. The attachment assembly of claim 3 wherein the outer surface includes one or more first raised ridges and the inner surface includes one or more second raised ridges that are aligned adjacent to the one or more first raised ridges when the inner surface is pressed against the outer surface.

5. The attachment assembly of claim 4 wherein the one or more first raised ridges extend from a lower portion of the outer surface to an upper portion of the outer surface, and the one or more second raised ridges extend from a lower portion on the inner surface to an upper portion on the inner surface.

6. The attachment assembly of claim 4 wherein the one or more first raised ridges include two or more first raised ridges that are parallel with one another, and the one or more second raised ridges include two or more second raised ridges that are parallel with one another.

7. The attachment assembly of claim 6 wherein the two or more first raised ridges are aligned parallel to the two or more second raised ridges when the inner surface is pressed against the outer surface.

8. The attachment assembly of claim 3 wherein the inner surface includes one or more notches.

9. The attachment assembly of claim 1 further comprising a locking mechanism configured to releasably lock the elongate fastening mechanism against the support member.

10. The attachment assembly of claim 1 further comprising one or more through-holes passing through the first clamping member, the second clamping member, and/or the support member.

11. The attachment assembly of claim 1 wherein the wherein the clamp mechanism includes a C clamp.

12. The attachment assembly of claim 2 further comprising a clamp section comprising spring material, the clamp section including a clamp section first end, a clamp section second end opposite the clamp section first end, and a clamp section body extending between the clamp section first end and the clamp section second end, the clamp section first end coupled to the upper surface and the clamp section body extending along the upper surface.

13. The attachment assembly of claim 1 further comprising a slider clamp member configured with the support member.

14. The attachment assembly of claim 1 further comprising an elastic clamp member configured with the support member.

15. The attachment assembly of claim 1 wherein the proximal end of the elongate fastening mechanism is located adjacent the second clamping member and the distal end of the elongate fastening mechanism extends along the support member towards the first clamping member.

16. An attachment assembly for attaching party decorations to a support structure, the attachment assembly comprising:
a clamp mechanism including a first clamping member, a second clamping member opposite the first clamping member, and a support member configured between the first clamping member and the second clamping member, the first clamping member and/or the second clamping member movable towards one another;
an elongate fastening mechanism including a proximal end rotatably coupled to the support member and adjacent the second clamping member and a distal end extending along the support member towards the first clamping member;
a bias mechanism configured to apply a force to the elongate fastening mechanism in a direction that presses the elongate fastening mechanism against the support member.

17. The attachment assembly of claim 16 wherein the first clamping member includes an upper surface, and wherein the distal end of the elongate fastening mechanism is adapted to extend over at least a portion of the upper surface when the bias mechanism causes the elongate fastening mechanism to be pressed against the support member.

18. The attachment assembly of claim 16 wherein the support member includes an outer surface and the elongate fastening mechanism includes an inner surface, and wherein the bias mechanism is configured to apply the force to the elongate fastening mechanism in a direction that presses the inner surface against the outer surface.

19. The attachment assembly of claim 18 wherein the outer surface includes one or more first raised ridges and the inner surface includes one or more second raised ridges that are aligned adjacent to the one or more first raised ridges when the inner surface is pressed against the outer surface.

20. The attachment assembly of claim 19 wherein the one or more first raised ridges extend from a lower portion of the outer surface to an upper portion of the outer surface, and the one or more second raised ridges extend from a lower portion on the inner surface to an upper portion on the inner surface, and wherein the one or more first raised ridges are aligned parallel to the one or more second raised ridges when the inner surface is pressed against the outer surface.
